(19) United States
(12) Patent Application Publication
(10) Pub. No.: US 2026/0128544 A1
(43) Pub. Date: May 7, 2026

(54) CONNECTOR AND CONNECTOR MANUFACTURING METHOD

(71) Applicant: Yazaki Corporation, Tokyo (JP)

(72) Inventors: Kazuhide IKEYA, Shizuoka (JP); Mai YOKOYAMA, Shizuoka (JP)

(73) Assignee: Yazaki Corporation, Tokyo (JP)

(21) Appl. No.: 19/348,863

(22) Filed: Oct. 3, 2025

(30) Foreign Application Priority Data
Oct. 7, 2024 (JP) 2024-175573

(51) Int. Cl. H01R 13/422; H01R 13/50; H01R 43/20

(52) U.S. Cl. CPC H01R 13/4226; H01R 13/50; H01R 43/20

(57) ABSTRACT

An object is to provide a connector and a connector manufacturing method capable of performing more appropriate assembly of a terminated wire to a housing member. The connector includes: a terminated wire; and a housing member that includes: a terminal housing section that is opened toward one end side in a height direction and houses the terminal of the terminated wire; a terminal engagement lock that is provided on a sidewall of the terminal housing section; and a terminal engagement block that is provided on a bottom wall of the terminal housing section. The housing member allows the terminal to be inserted into the terminal housing section along the height direction while bending the terminal engagement lock and the sidewall.

### CROSS-REFERENCE TO RELATED APPLICATION(S)

The present application claims priority to and incorporates by reference the entire contents of Japanese Patent Application No. 2024-175573 filed in Japan on Oct. 7, 2024.

### BACKGROUND OF THE INVENTION

### 1. Field of the Invention

The present invention relates to a connector and a connector manufacturing method.

### 2. Description of the Related Art

Conventional technologies related to connectors include, for example, Japanese Patent Application Laid-open No. 2019-16575.

This Japanese Patent Application Laid-open No. 2019-16575 discloses a connector that includes: a terminated wire; and a housing member including: a terminal housing section in which a terminal of the terminated wire is housed; a terminal engagement lock that is provided on a sidewall of the terminal housing section and restricts movement of the terminated wire along a height direction by abutting against the terminal; and a terminal engagement block that is provided on a bottom wall of the terminal housing section and restricts movement of the terminated wire along an axial direction by abutting against the terminal.

In this regard, with the connector disclosed in Japanese Patent Application Laid-open No. 2019-16575 described above, for example, the terminal is inserted into the terminal housing section of the housing member along the height direction while bending the terminal engagement lock and the sidewall. However, there is room for further improvement in terms of enabling more appropriate assembly of the terminated wire to the housing member.

### SUMMARY OF THE INVENTION

The present invention is designed in view of the aforementioned circumstances, and it is an object thereof to provide a connector and a connector manufacturing method capable of performing more appropriate assembly of a terminated wire to a housing member.

In order to achieve the above mentioned object, a connector according to one aspect of the present invention includes a terminated wire that includes an electric wire extending along an axial direction and a terminal provided at an end of the electric wire; and a housing member that includes: a terminal housing section that is opened toward one end side in a height direction intersecting with the axial direction and houses the terminal of the terminated wire; a terminal engagement lock that is provided on a sidewall of the terminal housing section and restricts movement of the terminal housed in the terminal housing section along the height direction by abutting against the terminal; and a terminal engagement block that is provided on a bottom wall of the terminal housing section and restricts movement of the terminal housed in the terminal housing section along the axial direction by abutting against the terminal, the housing member allowing the terminal to be inserted into the terminal housing section along the height direction while bending the terminal engagement lock and the sidewall, wherein the terminal engagement block includes: an engagement face that is engaged with the terminal along the axial direction; and a sloping face that slopes toward one end side of the axial direction as going from the engagement face toward the one end side of the height direction and guides the terminal toward the engagement face.

Further, in order to achieve the above mentioned object, a connector manufacturing method according to another aspect of the present invention includes a first step of inserting, into a terminal housing section that is provided in a housing member and opened toward one end side in a height direction intersecting with an axial direction of a terminated wire, a terminal of the terminated wire along the height direction while bending a sidewall of the terminal housing section and a terminal engagement lock provided on the sidewall; a second step of guiding, to a terminal engagement block provided on a bottom wall of the terminal housing section, the terminal toward an engagement face by a sloping face that slopes toward one end side of the axial direction as going from the engagement face of the terminal engagement block toward the one end side of the height direction; and a third step of engaging the terminal and the engagement face along the axial direction.

### BRIEF DESCRIPTION OF THE DRAWINGS

FIG. 1 is an exemplary perspective view of a connector according to an embodiment;

FIG. 2 is an exemplary exploded perspective view of the connector according to the embodiment;

FIG. 3 is an exemplary plan view of a housing member of the connector according to the embodiment;

FIG. 4 is an exemplary perspective view (partially in cross section) of the connector according to the embodiment;

FIG. 5 is an exemplary sectional view of the connector according to the embodiment, which is a diagram illustrating a state before insertion of the terminal into a terminal housing section;

FIG. 6 is an exemplary perspective view of the connector according to the embodiment, which is a diagram illustrating a state in the middle of insertion of the terminal into the terminal housing section;

FIG. 7 is an exemplary perspective view of the connector according to the embodiment, which is a diagram illustrating a state after insertion of the terminal into the terminal housing section;

FIG. 8 is an exemplary flowchart illustrating a connector manufacturing method according to the embodiment;

FIG. 9 is an exemplary explanatory diagram illustrating the connector manufacturing method according to the embodiment;

FIG. 10 is an exemplary perspective view of a connector according to a modification example; and

FIG. 11 is an exemplary explanatory diagram illustrating a connector manufacturing method according to the modification example.

### DETAILED DESCRIPTION OF THE PREFERRED EMBODIMENTS

Hereinafter, an embodiment and a modification example according to the present invention will be described in detail with reference to the accompanying drawings. Note, however, that the present invention is not limited by the embodiment and the modification example.

Furthermore, structural components in the following embodiment and modification example include those that can be easily replaced by those skilled in the art, or those that are substantially the same.

The embodiment and the modification example disclosed hereinafter also include similar structural components. Therefore, in the followings, common reference signs are applied to those similar structural components and duplicated explanations are avoided.

In this specification, it is to be noted that ordinal numbers are used only to distinguish parts, members, sites, positions, directions, and the like and do not indicate the order or priority.

### Embodiment

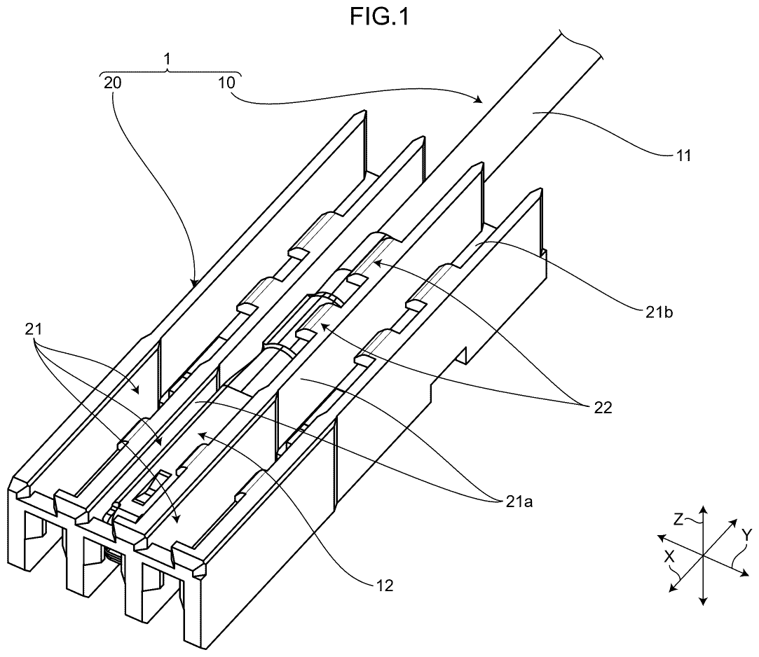

FIG. 1 is a perspective view of a connector 1 according to an embodiment. The connector 1 according to the present embodiment illustrated in FIG. 1 is incorporated into a wire harness that is routed in a vehicle such as an automobile. Here, a wire harness is, for example, a bundle of a plurality of electric wires 11 (terminated wires 10) used for power supply and signal communication formed into an assembly component for connecting between devices loaded on a vehicle, and the electric wires 11 are connected to each device by the connector 1 and the like. The connector 1 according to the present embodiment includes a plurality of the terminated wires 10 and a housing member 20 that holds a plurality of the terminated wires 10, for example. In addition, the connector 1 may also include various other structural components such as a lever and fixtures.

Note that in the description hereinafter, in regards to a first direction, a second direction, and a third direction intersecting with each other, the first direction is referred to as an “axial direction X”, the second direction as a “width direction Y”, and the third direction as a “height direction Z”. Herein, the axial direction X, the width direction Y, and the height direction Z are substantially orthogonal to each other. The axial direction X is typically along the extending direction of the electric wire 11 (terminated wire 10), the longitudinal direction of the housing member 20, the fitting direction (insertion direction) of the connector 1 and a mating connector, and the like. The width direction Y is typically along the radial direction of the electric wire 11, the width direction of the housing member 20 (connector 1), and the like. The height direction Z is typically along the radial direction of the electric wire 11, the height direction (up-and-down direction) of the housing member 20 (connector 1), and the like. Furthermore, unless otherwise noted, each of the directions used in the following description will be described as the direction in a state where the connector 1 is mounted onto a vehicle.

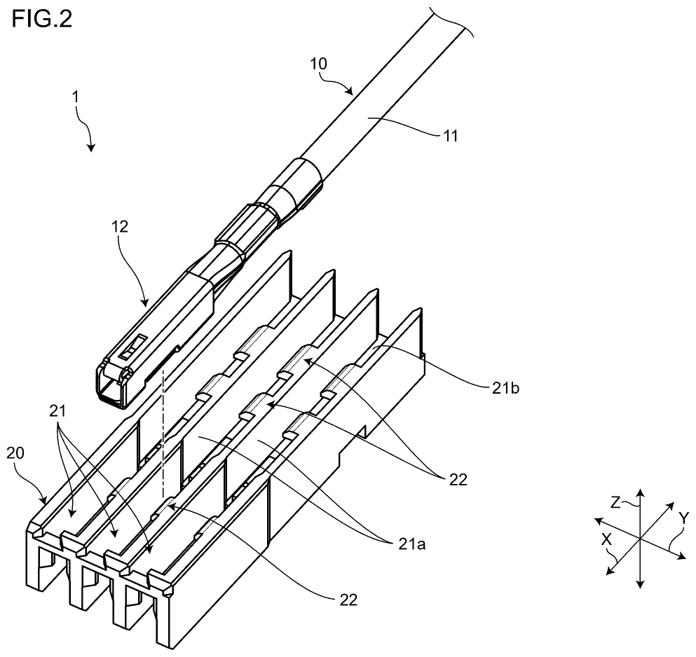

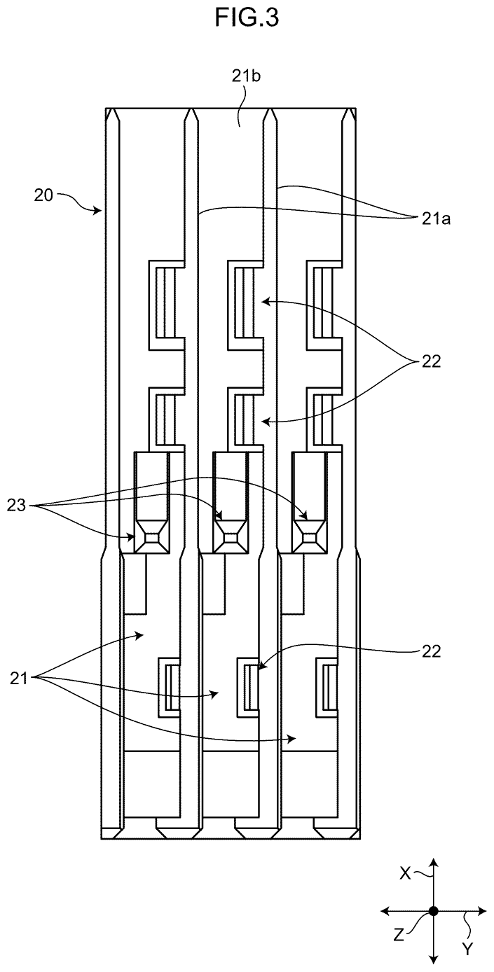

FIG. 2 is an exploded perspective view of the connector 1, and FIG. 3 is a plan view of the housing member 20 of the connector 1. As illustrated in FIGS. 2 and 3, the housing member 20 is, for example, the so-called kit-cut plate that forms part of an inner housing of the connector 1, and holds inside thereof the terminated wires 10 and the like. In the present embodiment, for example, several housing members 20 (kit-cut plates) with the terminated wires 10 assembled thereto are combined to configure the inner housing of the connector 1, and the inner housing is assembled to an outer housing to form the connector 1. In FIG. 1 to FIG. 4 and the like, only one of the pieces of terminated wires 10 is illustrated for convenience.

The housing member 20 is configured including, for example, a plurality of terminal housing sections 21, a plurality of terminal engagement locks 22, and a plurality of terminal engagement blocks 23 (see FIG. 3) described below. The terminal housing section 21 is where a terminal 12 of the terminated wire 10 is housed, and it is open toward one end side (upper side) in the height direction Z. In the present embodiment, the housing member 20 is provided with three terminal housing sections 21 lined along the width direction Y. Note that the number of terminal housing sections 21 is not limited to this example. For example, one, two, or four or more terminal housing sections 21 may be provided.

The terminal housing section 21 is configured including, for example, a pair of sidewalls 21a and a bottom wall 21b. The bottom wall 21b is the part that Supports the bottom face of the terminal 12 and is formed as a flat surface form extending along the direction (XY plane) that intersects with the height direction Z. The pair of sidewalls 21a are the parts that support the side faces of the terminal 12, which protrude from the bottom wall 21b along the height direction Z and extend along the axial direction X. In the present embodiment, for example, one of the pair of sidewalls 21a is shared between two terminal housing sections 21 adjacent to each other along the width direction Y. In other words, in the present embodiment, a total of four sidewalls 21a are provided for the three terminal housing sections 21 lined along the width direction Y. The pair of sidewalls 21a of the terminal housing section 21 located in the center of the three terminal housing sections 21 also function as partition walls that separate the terminal housing sections 21 adjacent to each other along the width direction Y.

The terminal engagement lock 22 is provided on the sidewall 21a of the terminal housing section 21, and restricts the movement of the terminal 12 housed in the terminal housing section 21 along the height direction Z by abutting against the terminal 12. The terminal engagement lock 22 is formed, for example, in a claw-like shape at one end (top end) of the sidewall 21a in the height direction Z. In the present embodiment, for example, each terminal housing section 21 is provided with three terminal engagement locks 22 lined along the axial direction X on one of the pair of sidewalls 21a. Each of the terminal engagement locks 22 has an engagement face that is engaged with the top face of the terminal 12 along the height direction Z. In the present embodiment, for example, when the engagement face of the terminal engagement lock 22 is engaged with the top face of the terminal 12 along the height direction Z while the terminal 12 is being housed in the terminal housing section 21, the movement (disengagement) of the terminal 12 along the height direction Z with respect to the terminal housing section 21 is suppressed.

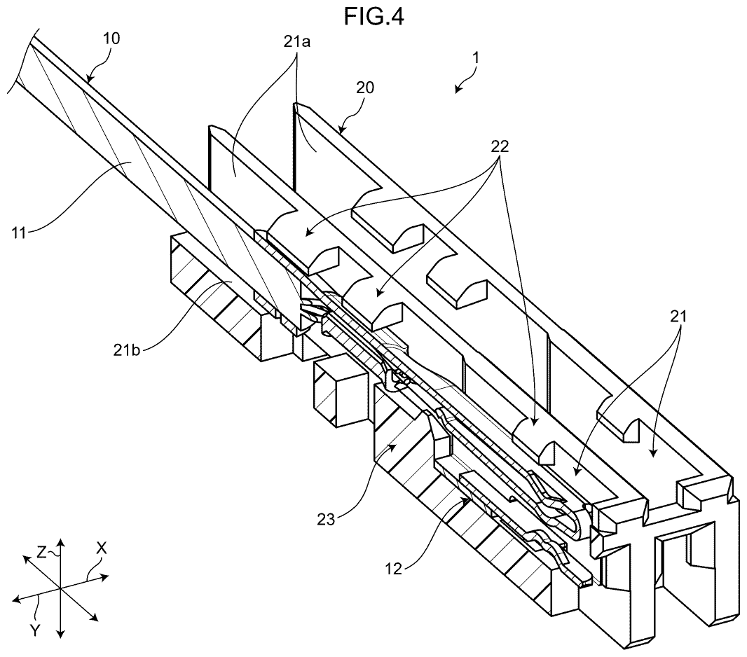

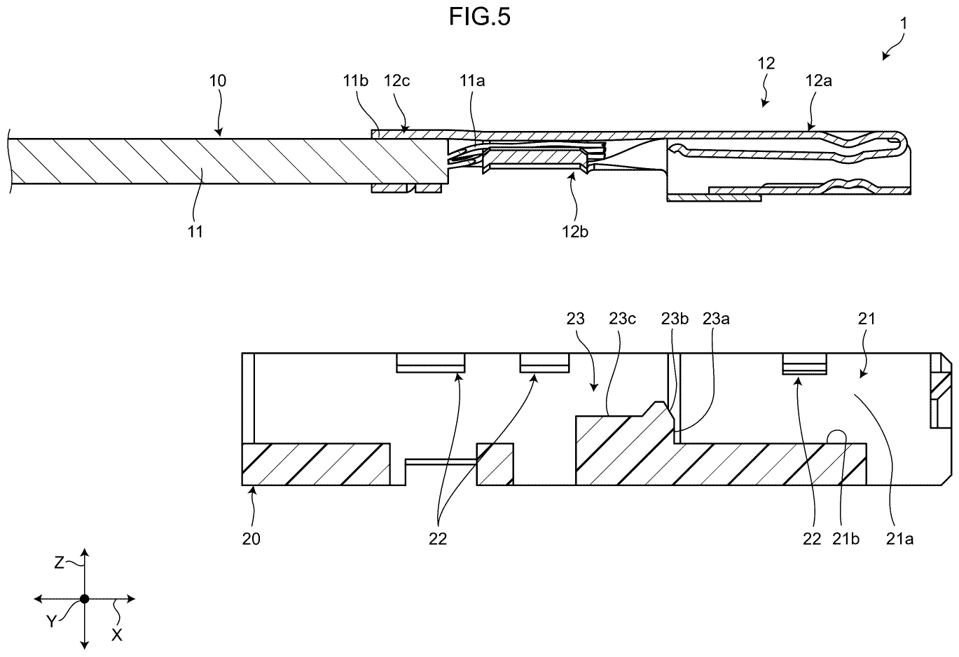

FIG. 4 is a perspective view of the connector 1 (partially in cross section), and FIG. 5 is a sectional view of the connector 1, which is a diagram illustrating a state before insertion of the terminal 12 into the terminal housing section 21. As illustrated in FIGS. 4 and 5, the terminated wire 10 is configured including the electric wire 11 and the terminal 12 provided at the end of the electric wire 11. The electric wire 11 is configured including a linear conductor part 11a exhibiting conductivity (see FIG. 5) and an insulating sheath part 11b exhibiting an insulation property, covering the outer side of the conductor part 11a. The electric wire 11 is an insulated electric wire in which the conductor part 11a is covered with the insulating sheath part 11b. While the conductor part 11a according to the present embodiment is a core wire configured with a plurality of conductive metal strands bundled together, it may also be a twisted core wire configured with a plurality of such metal strands twisted together.

The electric wire 11 is formed to extend linearly along the axial direction X and to extend with approximately the same diameter relative to the axial direction X (extending direction). The electric wire 11, for example, has a substantially circular cross-sectional shape for the conductor part 11a (cross-sectional shape intersecting with the axial direction X) and a substantially annular cross-sectional shape for the insulating sheath part 11b, forming a substantially circular cross-sectional shape as a whole. At least at one end of the electric wire 11, the insulating sheath part 11b is stripped off, and the terminal 12 is connected to the conductor part 11a that is exposed from the insulating sheath part 11b.

The terminal 12 is, for example, a female terminal fitting formed with a metal material exhibiting conductivity, and it is electrically connected to a mating terminal of a mating connector. The terminal 12 is configured including, for example, an electrical connection part 12a, a conductor joint part 12b, and a sheath joint part 12c. The electrical connection part 12a is engaged with an engagement face 23a (see FIG. 5) of the terminal engagement block 23 described below, and it is electrically connected to the mating terminal. The electrical connection part 12a is provided with, for example, a terminal insertion part (contact part) into which the mating terminal is inserted along the axial direction X.

The sheath joint part 12c is the part that is provided at the end on the opposite side from the electrical connection part 12a in the axial direction X, and joined to the insulating sheath part 11b of the electric wire 11. The sheath joint part 12c is, for example, joined to the insulating sheath part 11b of the electric wire 11 by crimping. The conductor joint part 12b is the part that is provided between the electrical connection part 12a and the sheath joint part 12c in the axial direction X, and joined to the conductor part 11a of the electric wire 11. The conductor joint part 12b is, for example, joined to the conductor part 11a of the electric wire 11 by crimping. Note that the joining method of the conductor joint part 12b and the sheath joint part 12c is not limited to such an example. For example, those parts may be joined to the conductor part 11a and the insulating sheath part 11b of the electric wire 11 by laser welding, ultrasonic welding, thermal welding, or the like.

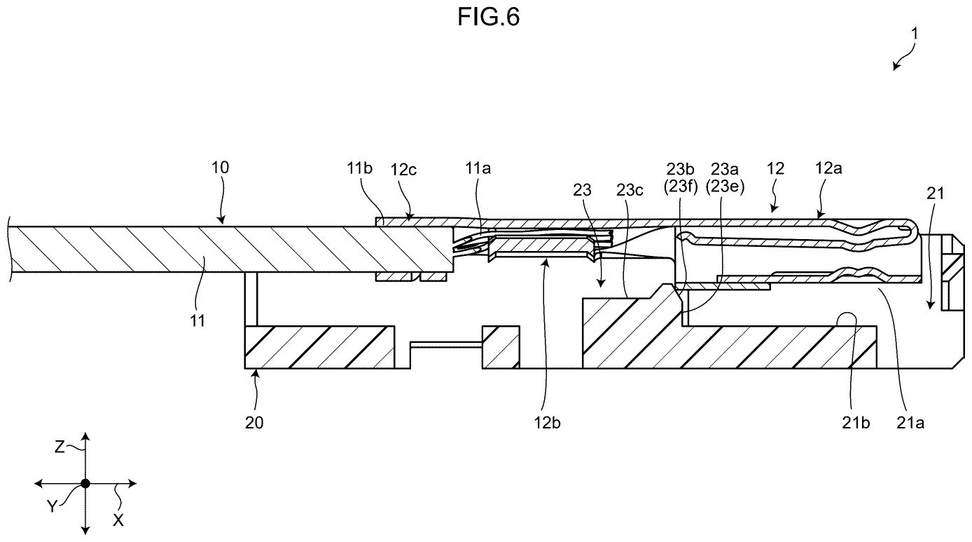

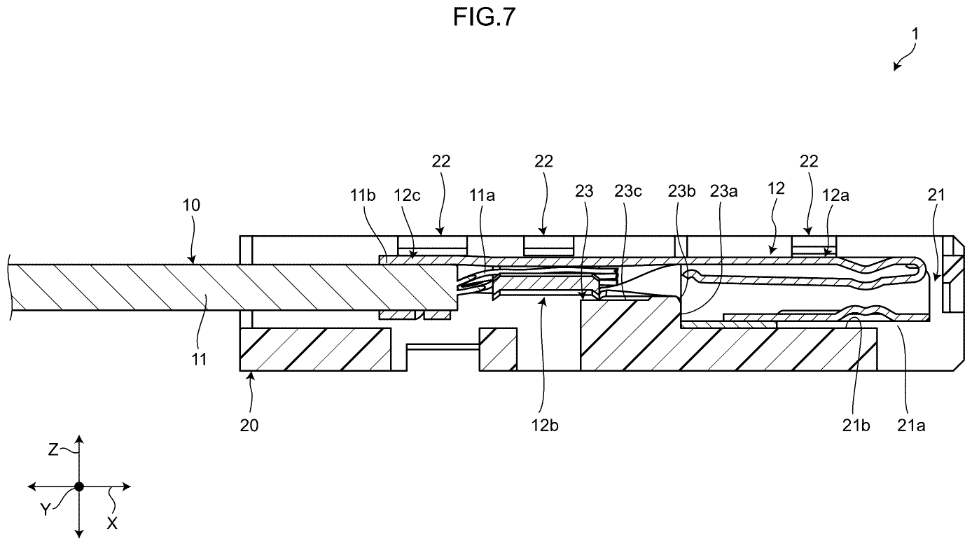

FIG. 6 is a perspective view of the connector 1, which is a diagram illustrating a state in the middle of insertion of the terminal 12 into the terminal housing section 21. FIG. 7 is a perspective view of the connector 1, which is a diagram illustrating a state after insertion of the terminal 12 into the terminal housing section 21.

As illustrated in FIGS. 6 and 7, the terminal engagement block 23 is, for example, provided on the bottom wall 21b of the terminal housing section 21, and restricts the movement of the terminal 12 housed in the terminal housing section 21 along the axial direction X by abutting against the terminal 12. In the present embodiment, for example, the terminal engagement block 23 is provided on the bottom wall 21b of each of the terminal housing sections 21, and a plurality of those terminal engagement blocks 23 are lined along the width direction Y.

The terminal engagement block 23 is configured including, for example, the engagement face 23a, a sloping face 23b, and a base face 23c. The engagement face 23a is the part of the terminal engagement block 23 engaged with the electrical connection part 12a of the terminal 12 along the axial direction X, and extends along the height direction Z. In the present embodiment, for example, the terminal engagement block 23 is provided protruding along the height direction Z from the bottom wall 21b of the terminal housing section 21, and the end face (side face) of the terminal engagement block 23 in the axial direction X configures the engagement face 23a. The terminal management block 23 protrudes in a two-step configuration with, for example, a first protrusion part 23e including the engagement face 23a and the base face 23c, and a second protrusion part 23f that includes the sloping face 23b and protrudes along the height direction Z from the first protrusion part 23e.

The sloping face 23b is the part of the terminal engagement block 23 to guide the electrical connection part 12a of the terminal 12 toward the engagement face 23a. The sloping face 23b, for example, slopes toward one end side of the axial direction X as going toward one end side (upper side) of the height direction Z from the engagement face 23a of the first protrusion part 23e. The sloping face 23b is configured, for example, by the end face (side face) in the axial direction X of the second protrusion part 23f of the terminal engagement block 23 described above. The second protrusion part 23f is formed to have a substantially trapezoidal shape in the cross section with, for example, the sloping face 23b, a flat top face extending from the sloping face 23b along the axial direction X, and a sloping face that slopes from the top face symmetrically with respect to the sloping face 23b.

The base face 23c is the part of the terminal engagement block 23 for supporting the conductor joint part 12b of the terminal 12. The base face 23c extends along the axial direction X, for example, and it is capable of suppressing the tilt of the conductor joint part 12b and the sheath joint part 12c with respect to the electrical connection part 12a by abutting against the conductor joint part 12b. The base face 23c is configured, for example, by one end face (top face) in the height direction Z of the first protrusion part 23e of the terminal engagement block 23 described above. In other words, in the terminal engagement block 23, the base face 23c is a flat face that is one step lower than the second protrusion part 23f where the sloping face 23b is formed, and it is positioned by being shifted to one end side in the axial direction X (the electric wire 11 side) with respect to the second protrusion part 23f (the electrical connection part 12a).

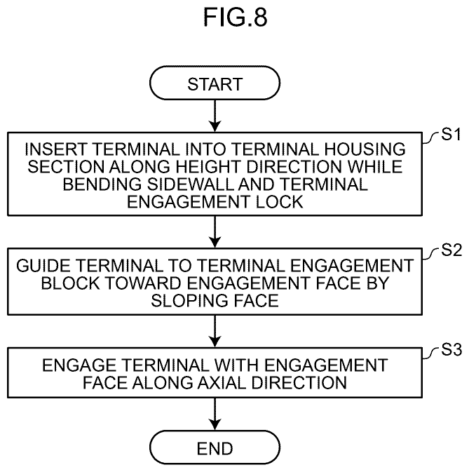

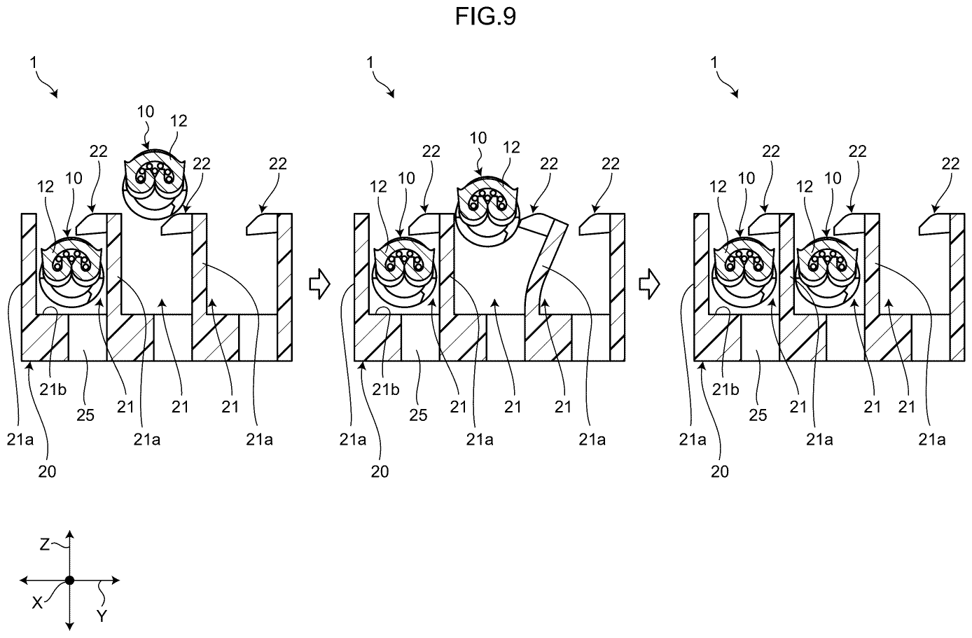

Next, an example of a manufacturing method (assembly method) of the connector 1 having the aforementioned configuration will be described. FIG. 8 is a flowchart illustrating the manufacturing method of the connector 1, and FIG. 9 is an explanatory diagram illustrating the manufacturing method of the connector 1. As illustrated in FIGS. 8 and 9, first, at a first step S1, the terminal 12 is inserted into the terminal housing section 21 along the height direction Z while bending the sidewall 21a and the terminal engagement lock 22. In this case, the terminals 12 of a plurality of the terminated wires 10 are inserted into a plurality of the terminal housing sections 21 sequentially from one end side to the other end side in the width direction Y.

At this time, the terminated wires 10 are inserted sequentially from the terminal housing section 21 side (left side in FIG. 9) having the sidewall 21a without providing the terminal engagement lock 22 among the terminal housing sections 21. This allows, in the insertion process of the terminated wire 10 into the terminal housing section 21, elastic deformation along the width direction Y of the terminal engagement lock 22 and the sidewall 21a where the terminal engagement lock 22 is provided. This makes it possible to enhance the assemblability of a plurality of the terminated wires 10 into a plurality of the terminal housing sections 21.

Next, at a second step S2, as illustrated in FIGS. 6 and 8, the terminal 12 is guided by the sloping face 23b to the terminal engagement block 23 toward the engagement face 23a. In this case, one end of the electrical connection part 12a of the terminal 12 in the axial direction X (the end on the conductor joint part 12b side) abuts against the sloping face 23b, and the electrical connection part 12a is guided by the sloping face 23b.

Next, at a third step S3, as illustrated in FIGS. 7 and 8, the terminal 12 and the engagement face 23a are engaged along the axial direction X. In this case, one end of the electrical connection part 12a in the axial direction X abuts against the engagement face 23a, and the electrical connection part 12a and the engagement face 23a are engaged along the axial direction X. Through such first step S1 to third step S3, a plurality of the terminated wires 10 can be assembled to a plurality of the terminal housing sections 21 to produce the connector 1. Note that the manufacturing method of the connector 1 is not limited to this example. For example, it may include a step of forming an inner housing of the connector 1 by combining several housing members 20 (kit-cut plates) to which a plurality of the terminated wires 10 are assembled, and the like.

As described above, in the connector 1 and the manufacturing method of the connector 1 according to the present embodiment, the terminal engagement block 23 includes: the engagement face 23a that is engaged with the terminal 12 along the axial direction X; and the sloping face 23b that slopes toward the one end side of the axial direction X as going from the engagement face 23a toward the one end side of the height direction Z, and guides the terminal 12 toward the engagement face 23a. This configuration allows the connector 1 and the manufacturing method of the connector 1 to guide the terminal 12 toward the engagement face 23a by the sloping face 23b, for example. This makes it possible to absorb misalignment of the terminal 12 with respect to the engagement face 23a along the axial direction X. As a result, the connector 1 and the manufacturing method of the connector 1 can more appropriately assemble the terminated wire 10 to the housing member 20.

Furthermore, in the connector 1 according to the present embodiment, the terminal 12 is configured including: the electrical connection part 12a that is engaged with the engagement face 23a and electrically connected to the mating terminal; and the conductor joint part 12b that is joined to the conductor part 11a of the electric wire 11. The terminal engagement block 23 includes the base face 23c that extends along the axial direction X and supports the conductor joint part 12b. With this configuration, the connector 1 can suppress the tilt of the conductor joint part 12b, the sheath joint part 12c, and the like with respect to the electrical connection part 12a by the base face 23c, for example. This makes it possible to correct and hold the terminated wire 10 in the proper posture.

Furthermore, in the connector 1 according to the present embodiment, the housing member 20 has a plurality of the terminal engagement locks 22, and the terminal engagement locks 22 are provided in line along the axial direction X on one of the pair of sidewalls 21a of the terminal housing section 21. This configuration allows the connector 1 to have the terminal 12 locked by the terminal engagement locks 22, for example, while allowing the sidewall 21a where the terminal engagement locks 22 are provided to bend along the width direction Y to the adjacent terminal housing section 21 side when a plurality of the terminal housing sections 21 are provided in line along the width direction Y. Therefore, assemblability of the terminated wire 10 to the housing member 20 can be enhanced further.

### Modification Example

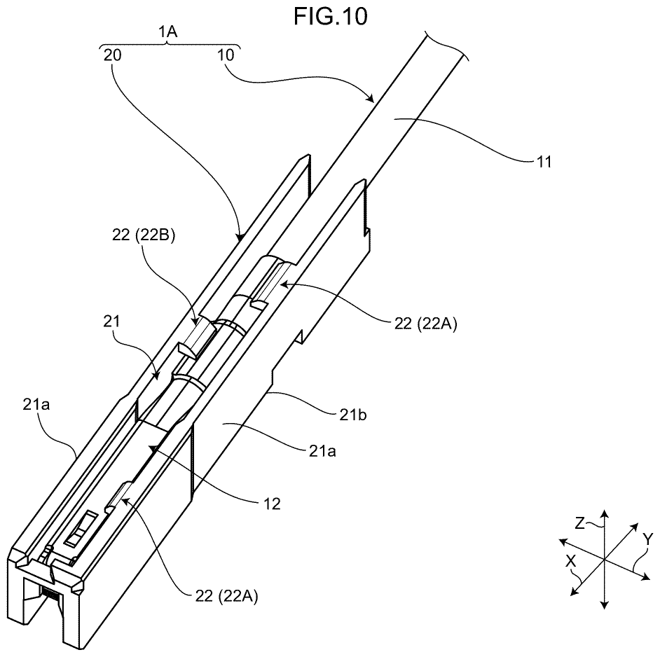

FIG. 10 is a perspective view of a connector 1A according to a modification example. The connector 1A illustrated in FIG. 10 has the same configuration as that of the connector 1 of the embodiment described above. Therefore, the connector 1A can acquire the same actions and effects as those of the above-described embodiment based on the similar configuration.

However, as illustrated in FIG. 10, the present modification example differs from the above-described embodiment in that one terminal housing section 21 is provided in the housing member 20 and that the terminal engagement lock 22 is provided on each of the pair of sidewalls 21a of the terminal housing section 21. In other words, in the present modification example, the terminal engagement lock 22 is configured including first terminal engagement locks 22A provided on one of the pair of sidewalls 21a and a second terminal engagement lock 22B provided on the other of the pair of sidewalls 21a.

In the present modification example, for example, the first terminal engagement locks 22A are provided in a pair on one of the pair of sidewalls 21a with a space provided therebetween along the axial direction X. On the other hand, the second terminal engagement lock 22B is provided to be positioned between the pair of first terminal engagement locks 22A on the other of the pair of sidewalls 21a. That is, the first terminal engagement locks 22A and the second terminal engagement lock 22B are provided on each of the pair of sidewalls 21a while being shifted from each other along the axial direction X.

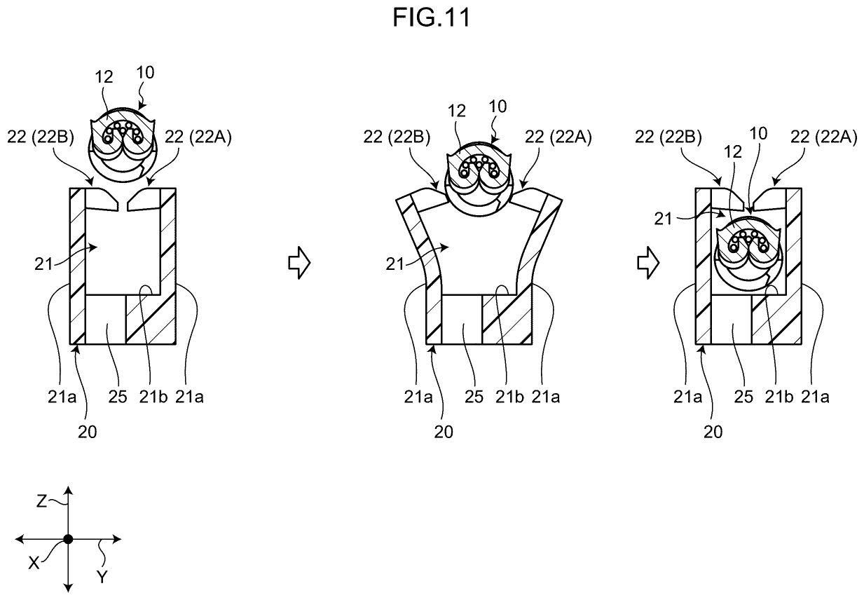

Next, an example of a manufacturing method (assembly method) of the connector 1A having the above configuration will be described. FIG. 11 is an explanatory diagram illustrating the manufacturing method of the connector 1A according to the modification example. As illustrated in FIG. 11, first, at a first step S1, the terminal 12 is inserted into the terminal housing section 21 along the height direction Z while bending the sidewall 21a and the terminal engagement lock 22. In this case, as the terminal 12 is inserted into the terminal housing section 21, the first terminal engagement locks 22A as well as the second terminal engagement locks 22B and the pair of sidewalls 21a elastically deform toward the sides away from each other along the width direction Y.

Next, at a second step S2, as illustrated in FIG. 6, the terminal 12 is guided by the sloping face 23b to the terminal engagement block 23 toward the engagement face 23a. In this case, one end of the electrical connection part 12a of the terminal 12 in the axial direction X (the end on the conductor joint part 12b side) abuts against the sloping face 23b, and the electrical connection part 12a is guided by the sloping face 23b.

Next, at a third step S3, as illustrated in FIG. 7, the terminal 12 and the engagement face 23a are engaged along the axial direction X. In this case, one end of the electrical connection part 12a in the axial direction X abuts against the engagement face 23a, and the electrical connection part 12a and the engagement face 23a are engaged along the axial direction X. Through such first step S1 to third step S3, the terminated wire 10 can be assembled to the terminal housing section 21 to produce the connector 1A. Note that the manufacturing method of the connector 1A is not limited to this example. For example, it may include a step of forming an inner housing of the connector 1A by combining several housing members 20 (kit-cut plates) to which the terminated wire 10 is assembled, and the like.

As described above, in the connector 1A according to the present modification example, the housing member 20 has a plurality of the terminal engagement locks 22, and the terminal engagement locks 22 are provided by being shifted from each other along the axial direction X in each of the pair of sidewalls 21a of the terminal housing section 21. In the connector 1A with such a configuration, for example, it is possible to engage the terminal 12 by the terminal engagement locks 22 and to further suppress the movement (disengagement) of the terminal 12 along the height direction Z with respect to the terminal housing section 21 by the terminal engagement locks 22 that are provided in an alternating manner.

While the cases where three terminal engagement locks 22 are provided on the pair of the sidewalls 21a of the terminal housing section 21 is illustrated in the present modification example and the above-described embodiment, it is not intended to be limited to such cases. For example, one, two, or four or more terminal engagement locks 22 may be provided on the pair of the sidewalls 21a of the terminal housing section 21. In addition, while the cases where the base face 23c is provided in the terminal engagement block 23 is illustrated in the present modification example and the above-described embodiment, it is not intended to be limited to such cases. For example, the base face 23c may be provided on the bottom wall 21b of the terminal housing section 21.

While the embodiment and the modification example of the present invention are described above, the embodiment and the modification example are examples and not intended to limit the scope of the present invention. The above-described embodiment and modification example can be implemented in various other forms, and various omissions, substitutions, combinations, and changes can be made without departing from the gist of the present invention. In addition, each configuration, shape, and other specifications (structure, type, direction, form, size, length, width, thickness, height, number, layout, position, material, and the like) can be changed as appropriate.

In the connector and the connector manufacturing method according to the present invention, the terminal engagement block includes: the engagement face that is engaged with the terminal along the axial direction; and the sloping face that slopes toward the one end side of the axial direction X as going from the engagement face toward the one end side of the height direction, and guides the terminal toward the engagement face. This configuration allows the connector and the connector manufacturing method to guide the terminal toward the engagement face by the sloping face, for example. This makes it possible to absorb misalignment of the terminal with respect to the engagement face along the axial direction. As a result, the connector and the connector manufacturing method can achieve such an effect that the terminated wire can be more appropriately assembled to the housing member.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A connector comprising:
a terminated wire that includes an electric wire extending along an axial direction and a terminal provided at an end of the electric wire; and
a housing member that includes: a terminal housing section that is opened toward one end side in a height direction intersecting with the axial direction and houses the terminal of the terminated wire; a terminal engagement lock that is provided on a sidewall of the terminal housing section and restricts movement of the terminal housed in the terminal housing section along the height direction by abutting against the terminal; and a terminal engagement block that is provided on a bottom wall of the terminal housing section and restricts movement of the terminal housed in the terminal housing section along the axial direction by abutting against the terminal, the housing member allowing the terminal to be inserted into the terminal housing section along the height direction while bending the terminal engagement lock and the sidewall, wherein
the terminal engagement block includes: an engagement face that is engaged with the terminal along the axial direction; and a sloping face that slopes toward one end side of the axial direction as going from the engagement face toward the one end side of the height direction and guides the terminal toward the engagement face.

2. The connector according to claim 1, wherein
the terminal includes: an electrical connection part that is engaged with the engagement face and electrically connected to a mating terminal; and a conductor joint part that is joined to a conductor part of the electric wire, and
the terminal engagement block includes a base face that extends along the axial direction and supports the conductor joint part.

3. The connector according to claim 1, wherein
the housing member includes a plurality of the terminal engagement locks, and
the terminal engagement locks are provided in line along the axial direction on one of a pair of the sidewalls of the terminal housing section.

4. The connector according to claim 2, wherein
the housing member includes a plurality of the terminal engagement locks, and
the terminal engagement locks are provided in line along the axial direction on one of a pair of the sidewalls of the terminal housing section.

5. The connector according to claim 1, wherein
the housing member includes a plurality of the terminal engagement locks, and
the terminal engagement locks are provided by being shifted from each other along the axial direction on each of a pair of the sidewalls of the terminal housing section.

6. The connector according to claim 2, wherein
the housing member includes a plurality of the terminal engagement locks, and
the terminal engagement locks are provided by being shifted from each other along the axial direction on each of a pair of the sidewalls of the terminal housing section.

7. A connector manufacturing method comprising:
a first step of inserting, into a terminal housing section that is provided in a housing member and opened toward one end side in a height direction intersecting with an axial direction of a terminated wire, a terminal of the terminated wire along the height direction while bending a sidewall of the terminal housing section and a terminal engagement lock provided on the sidewall;
a second step of guiding, to a terminal engagement block provided on a bottom wall of the terminal housing section, the terminal toward an engagement face by a sloping face that slopes toward one end side of the axial direction as going from the engagement face of the terminal engagement block toward the one end side of the height direction; and
a third step of engaging the terminal and the engagement face along the axial direction.
